(19) United States
(12) Patent Application Publication
(10) Pub. No.: US 2026/0270820 A1
(43) Pub. Date: Sep. 10, 2026

(54) TERMINAL

(71) Applicant: NTT DOCOMO, INC., Tokyo (JP)

(72) Inventors: Koki YAMASHITA, Tokyo (JP); Tianyang MIN, Tokyo (JP); Mio NAKAMURA, Tokyo (JP)

(73) Assignee: NTT DOCOMO, INC., Tokyo (JP)

(21) Appl. No.: 19/489,299

(22) PCT Filed: Aug. 7, 2023
(86) PCT No.: PCT/JP2023/028824

§ 371 Date: Dec. 2, 2025

(51) Int. Cl. H04W 36/04; H04W 36/00

(52) U.S. Cl. CPC H04W 36/04; H04W 36/0061

(57) ABSTRACT

A terminal includes a reception unit that receives a reconfiguration message from a base station in a radio resource control layer, and a control unit that transitions to a selected cell in a lower layer than the radio resource control layer, in which, the control unit, if the selected cell is a candidate cell in a transition of the lower layer and reconfiguration information relating to the transition of the lower layer is included in the reconfiguration message, applies a configuration relating to the candidate cell and transitions to the candidate cell without a request to the base station on transition to the candidate cell.

### TECHNICAL FIELD

The present disclosure relates to a terminal.

### BACKGROUND ART

The 3rd Generation Partnership Project (3GPP: Registered Trademark) has prepared a specification for the 5th generation mobile communication system (which may be called 5G, New Radio (NR), or Next Generation (NG) ), and is also in the process of specifying the next generation called Beyond 5G, 5G Evolution, or 6G.

In 3GPP Release 18, the enhancement of Layer 1/Layer 2 mobility (L1/L2 mobility) is discussed. L1/L2 mobility, which is also called lower layer triggered mobility (LTM), is a technology relating to mobility of a terminal (User Equipment, UE) in L1/L2, for example, handover (HO) (Non-Patent Literature 1). HO in L1/L2 is controlled by a lower layer that is lower than a radio resource control (RRC) layer. As described above, the mobility in L1/L2 is sometimes referred to as LTM. However, for convenience of explanation, HO in L1/L2 is hereinafter specifically referred to as LTM.

In addition, it is agreed that fast recovery to a candidate cell is supported when a radio link failure (RLF) or LTM execution Failure (hereinafter also referred to as LTM Failure) occurs in LTM (Non-Patent Literature 2).

### CITATION LIST

### Non-Patent Literature

Non-Patent Literature 1: “Further NR Mobility Enhancements”, RP-222332, 3GPP TSG RAN Meeting #97-e, 3GPP, Sep. 12-16, 2022
Non-Patent Literature 2: “Status Report to TSG”, RP-231311, 3GPP TSG RAN Meeting #100, 3GPP, Jun. 12-14, 2023

### SUMMARY OF INVENTION

Fast recovery in LTM is a mechanism for transition to a candidate cell without a request to the base station on transition to the candidate cell when a predetermined condition is satisfied, similar to fast recovery in conditional handover (CHO), for example. However, the fast recovery in LTM has a problem in that a mechanism of fast recovery in CHO cannot be applied as is because an involvement of an RRC layer differs from that in the fast recovery in CHO.

The present disclosure has been made in view of such a situation, and an object thereof is to provide a terminal capable of realizing fast recovery in LTM.

An aspect of the present disclosure is a terminal (UE 200) including: a reception unit (transmission and reception unit 210) that receives a reconfiguration message from a base station in a radio resource control layer; and a control unit (control unit 240) that transitions to a selected cell in a lower layer than the radio resource control layer, in which, the control unit, if the selected cell is a candidate cell in a transition of the lower layer and reconfiguration information relating to the transition of the lower layer is included in the reconfiguration message, applies a configuration relating to the candidate cell and transitions to the candidate cell without a request to the base station on transition to the candidate cell.

An aspect of the present disclosure is a terminal (UE 200) including: a reception unit (transmission and reception unit 210) that receives a reconfiguration message from a base station in a radio resource control layer; and a control unit (control unit 240) that in a lower layer than the radio resource control layer, transitions to a candidate cell determined based on a threshold among candidate cells in a transition of the lower layer, in which the control unit applies a configuration relating to the candidate cell and transitions to the candidate cell without a request to the base station on transition to the candidate cell.

### BRIEF DESCRIPTION OF DRAWINGS

FIG. 1 is an overall schematic configuration diagram of a radio communication system.

FIG. 2 is a diagram illustrating frequency ranges used in the radio communication system.

FIG. 3 is a diagram illustrating a configuration example of a radio frame, a sub-frame, a slot, and a symbol used in the radio communication system.

FIG. 4 is a functional block diagram of a terminal.

FIG. 5 is a functional block diagram of a base station.

FIG. 6 is a sequence diagram illustrating an example of LTM.

FIG. 7 is a flowchart illustrating an example of fast recovery in LTM when RLF/HOF/LTM Failure occurs.

FIG. 8 is a sequence diagram illustrating an example of fast recovery in LTM when BF occurs.

FIG. 9 is a flowchart illustrating an example of fast recovery in LTM when BF occurs.

FIG. 10 is a diagram illustrating an example of a hardware configuration of the base station and the terminal.

FIG. 11 is a diagram illustrating a configuration example of a vehicle.

### DESCRIPTION OF EMBODIMENT

An embodiment will be described below based on the drawings. Note that the same or similar reference numerals have been attached to the same functions and configurations, and a description thereof will be omitted as appropriate.

### (1) Overall Schematic Configuration of Radio Communication System

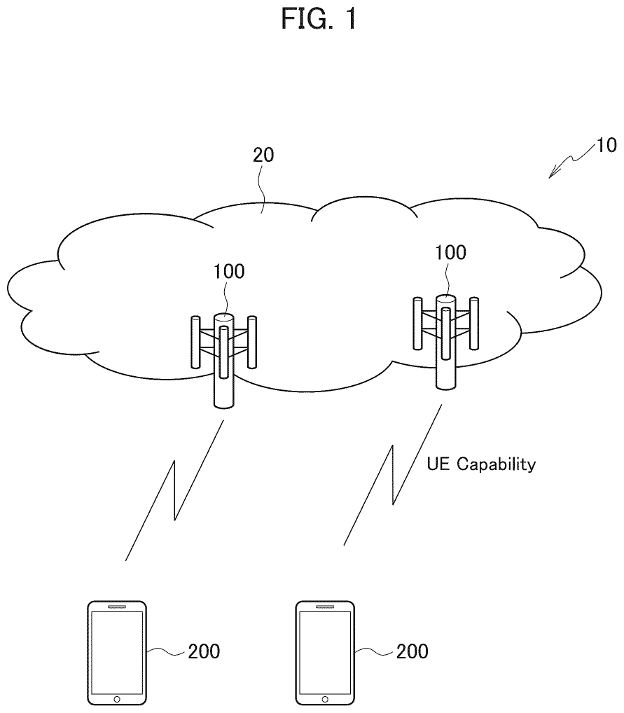

A radio communication system 10 illustrated in FIG. 1 is a radio communication system according to a scheme called 5G. Meanwhile, the radio communication system 10 may be a radio communication system according to a scheme called Beyond 5G, 5G Evolution, or 6G.

The radio communication system 10 can support Massive Multiple-Input Multiple-Output (Massive MIMO) that generates a beam with higher directivity by controlling radio signals transmitted from multiple antenna elements, carrier aggregation (CA) that uses multiple component carriers (CCs) bundled together, dual connectivity (DC) that simultaneously performs communication with two base stations, and the like.

As illustrated in FIG. 1, the radio communication system 10 includes a base station (gNodeB, gNB) 100 connected to a Next Generation-Radio Access Network (NG-RAN) 20, and a terminal (User Equipment, UE) 200 that performs a radio communication with the gNB 100. The NG-RAN 20 is connected to a core network (CN), which is not illustrated. The CN is constituted by Network Functions (NFs) such as an Access and Mobility Management Function (AMF). The NG-RAN 20 and the CN may be simply referred to as a “network”, and may be interpreted to be included in the radio communication system 10 or not. The specific configuration of the radio communication system 10, for example, the number of gNBs 100 and UEs 200, is not limited to the example illustrated in FIG. 1.

The UE 200 in the embodiment supports HO (hereinafter also referred to as LTM) controlled in layer 1/layer 2 (L1/L2, e.g., Media Access Control (MAC) layer), which are lower layers than layer 3 (L3, e.g., RRC layer). That is, the UE 200 can transition to a selected cell, or a candidate cell in lower layer transition (hereinafter also referred to as an LTM candidate cell or simply a candidate cell) based on lower layer control. The LTM has an advantage in that the time required for HO is shorter than that for HO controlled in conventional L3. In the following description, HO may be referred to as transition.

Furthermore, the UE 200 in the embodiment supports fast recovery in LTM. Fast recovery in LTM is a mechanism for transition to a candidate cell without a request to the gNB 100 on transition to the candidate cell when a predetermined condition is satisfied, similar to fast recovery in CHO, for example. Note that the request on transition to the candidate cell may be read as meaning a request on RRC reconnection to the candidate cell or transmission of a request on RRC reconnection (RRC re-establishment request) to the candidate cell.

Fast recovery in LTM is executed, for example, when the UE 200 detects a communication failure with the gNB 100. Here, the failure may be interpreted as a concept that includes a handover failure (HOF) and a beam failure (BF) in addition to the RLF and LTM failure described above. In other words, RLE, LTM Failure, HOF, and BF may be read interchangeably with each other in terms of a communication failure with the gNB 100.

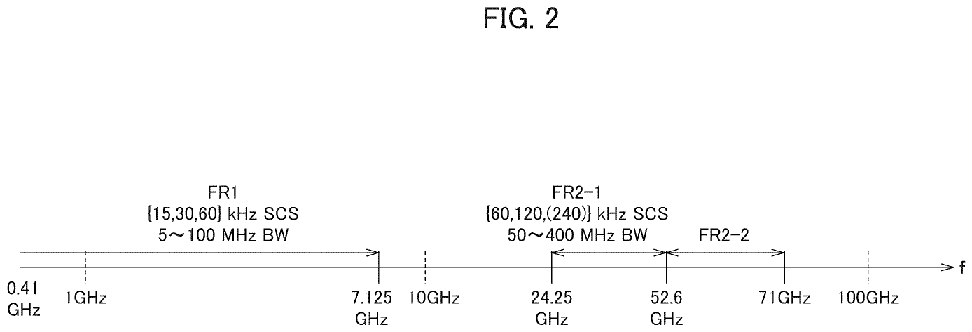

Further, the radio communication system 10 may Support multiple frequency ranges (FRs). That is, as illustrated in FIG. 2, the radio communication system 10 may support the following FRs.
FR1: 410 MHz to 7.125 GHz
FR2-1: 24.25 GHz to 52.6 GHz
FR2-2: Over 52.6 GHz to 71 GHz

In FR1, sub-carrier spacing (SCS) of 15, 30, or 60 KHz and a bandwidth (BW) of 5 to 100 MHz may be used. In FR2-1, SCS of 60 120 kHz (with 240 kHz potentially included) and a BW of 50 to 400 MHz may be used.

In FR2-2, Cyclic Prefix-Orthogonal Frequency Division Multiplexing (CP-OFDM) or Discrete Fourier Transform-Spread-Orthogonal Frequency Division Multiplexing (DFT-S-OFDM) having a larger SCS may be applied in order to avoid an increase in phase noise.

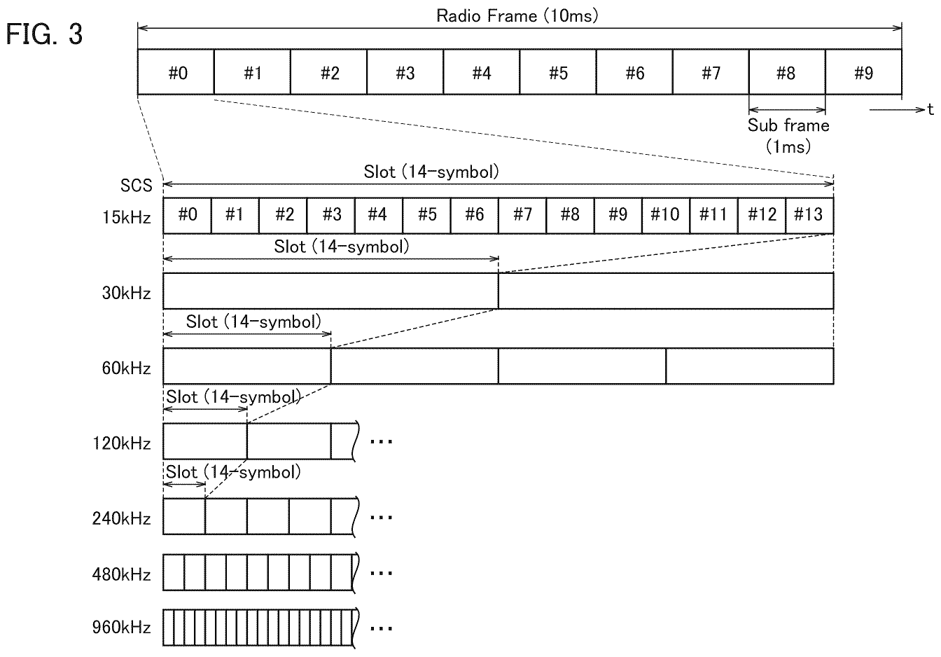

Further, as illustrated in FIG. 3, one slot in the radio communication system 10 is constituted of 14 symbols. When this constitution is maintained, a symbol period (and slot period) becomes shorter as the SCS becomes larger (wider). Note that the SCS is not limited to the frequency illustrated in FIG. 3, and may be a frequency of 480 kHz or 960 kHz, for example.

Further, the number of symbols constituting one slot is not necessarily 14 symbols, and may be 28 or 56 symbols, for example. Further, the number of slots per sub-frame may vary depending on the SCS.

### (2) Functional Block Configuration of 41 Radio Communication System

### (2.1) Functional Block Configuration of Terminal

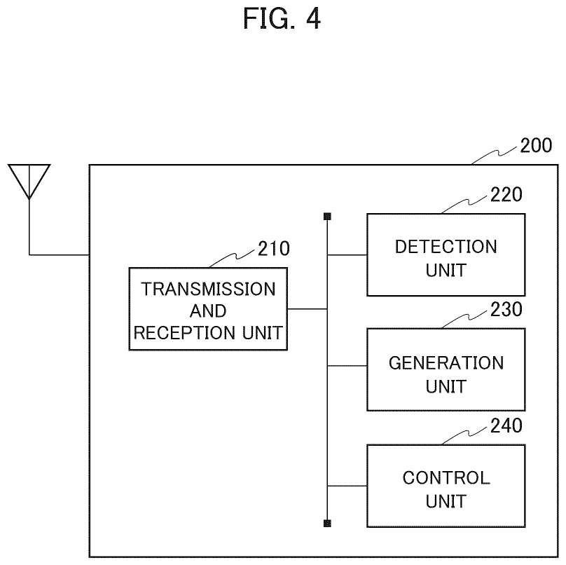

As illustrated in FIG. 4, the UE 200 includes a transmission and reception unit 210, a detection unit 220, a generation unit 230, and a control unit 240.

The transmission and reception unit 210 transmits and receives radio signals to and from the gNB 100. The transmission and reception unit 210 may include a transmission unit that transmits radio signals to the gNB 100 and a reception unit that receives radio signals from the gNB 100.

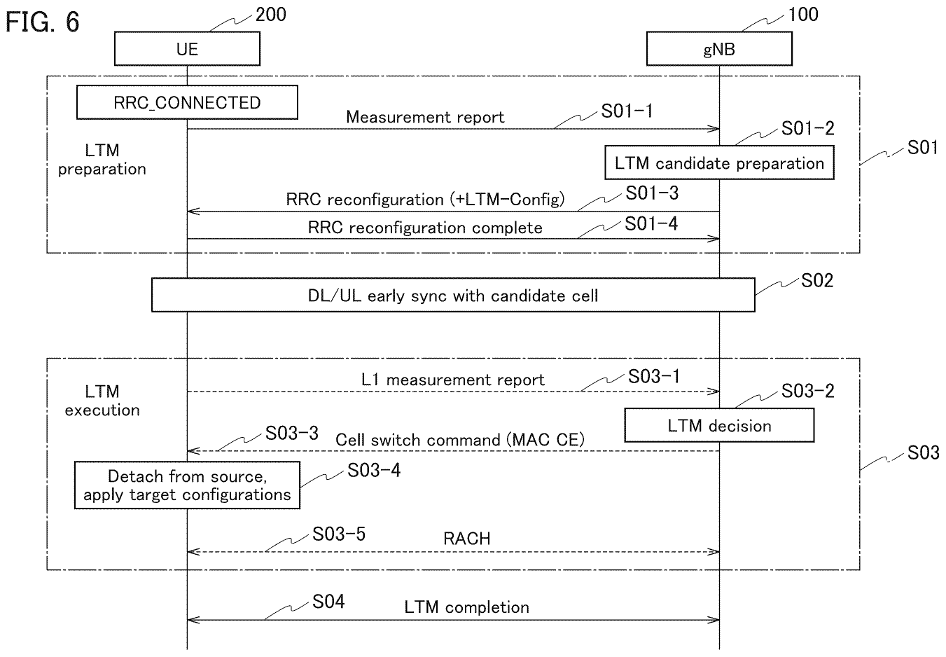

The transmission and reception unit 210 in the embodiment transmits a measurement report to the gNB 100. The measurement report includes a conventional measurement report transmitted in L3 (for example, RRC layer) and an L1 measurement report transmitted in L1 (see FIG. 6). Further, the transmission and reception unit 210 transmits various messages such as RRC reconfiguration complete to the gNB 100. The measurement report may be generated by the generation unit 230 when a failure is detected by the detection unit 220. Similarly, various messages may be generated by the generation unit 230.

The transmission and reception unit 210 in the embodiment receives a reconfiguration message (for example, RRC Reconfiguration) from the gNB 100 in the RRC layer. The reconfiguration message may include various IEs such as configuration information (for example, LTM-Config) relating to a transition of a lower layer (LTM). In particular, the reconfiguration message in the embodiment may include reconfiguration information (for example, attemptLTM-Reconfig) relating to the LTM, and further may include BFR configuration information (for example, BFR-Config for LTM) relating to the LTM candidate cell. Note that the “attemptLTM-Reconfig” is a tentative name, and other names may be used as long as the IE has the same function. The same applies to the other IEs. The IEs that can be included in the reconfiguration message will be described in detail in the operation examples.

The transmission and reception unit 210 in the embodiment may receive a MAC Control Element (CE) from the gNB 100 in the MAC layer. The MAC CE may include a Cell switch command (see FIG. 6).

The detection unit 220 detects various failures such as RLF, LTM Failure, HOF, and BF described above. Specifically, the detection unit 220 measures the quality of serving cells formed by the gNB 100 or the quality of beams in the serving cell, and compares the measured quality with a predetermined threshold, thereby determining whether a communication failure occurs with the gNB 100. In addition, the detection unit 220 can measure the quality of LTM candidate cells, or the quality of other beams in the serving cell or the quality of beams in the LTM candidate cell. Note that these cells or beams may have their qualities determined by, for example, the control unit 240 through comparison with a predetermined threshold.

The detection unit 220 may output a measurement result to the generation unit 230 such that the generation unit 230 generates a measurement report. In addition, the detection unit 220 may output the measurement result to the control unit 240 such that the control unit 240 executes a cell selection or beam selection in LTM.

The generation unit 230 generates a measurement report and various messages. The measurement report and various messages will be described in detail in the operation examples.

The control unit 240 controls transmission and reception of radio signals by the transmission and reception unit 210, detection of various failures by the detection unit 220, and generation of measurement reports and various messages by the generation unit 230.

The control unit 240 in the embodiment executes HO of the UE 200. The control unit 240 may execute HO in the L3 or HO (LTM) in the L1/L2. Note that although executing HO/LTM may mean executing HO/LTM based on control (HO/LTM determination) by the control unit 130 of the gNB 100, particularly in the embodiment, it may mean executing fast recovery not based on HO/LTM determination by the gNB 100. In other words, the control unit 240 can transition to the LTM candidate cell without a request to the gNB 100 on transition to the LTM candidate cell. The transition to the LTM candidate cell by the control unit 240 will be briefly described below.

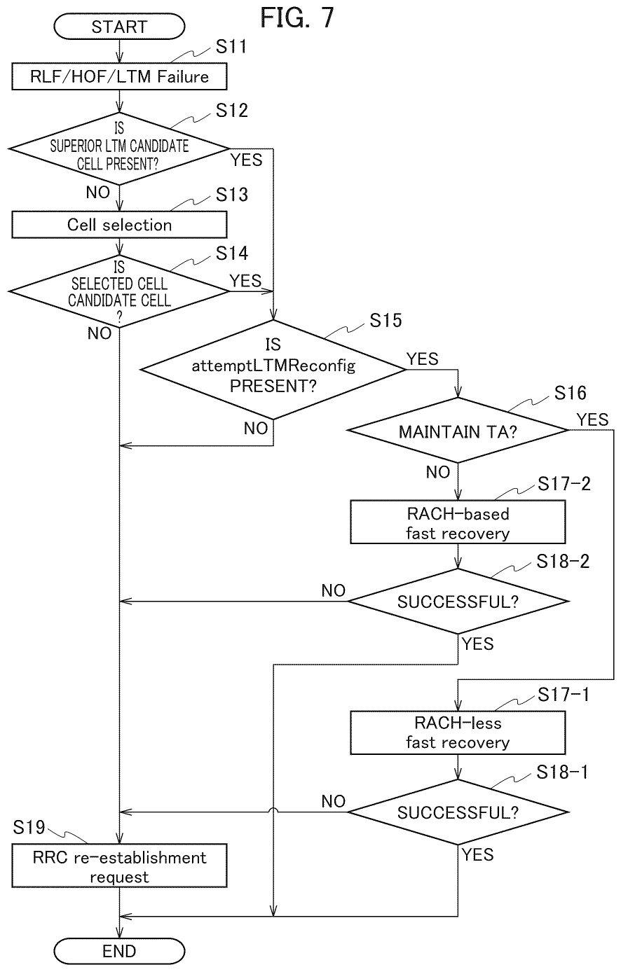

That is, the control unit 240 can select a cell and transition to the cell having been selected (selected cell) in HO/LTM. At this time, if the selected cell is the LTM candidate cell and the reconfiguration information relating to the LTM described above is included in the reconfiguration message transmitted from the gNB 100, the control unit 240 can apply the configuration relating to the LTM candidate cell and transition to the LTM candidate cell without a request to the gNB 100 on transition to the LTM candidate cell. A more detailed sequence will be described in detail in the operation example (see FIG. 7). Note that the cell selection may be executed based on the measurement result described above, and the LTM candidate cell may be interpreted to be a cell formed by the gNB 100 supporting the LTM. Furthermore, the selected cell may be interpreted to be a cell that is determined for transition, and the candidate cell may be interpreted to be a cell having a possibility of transition.

Further, the control unit 240 can transition to the LTM candidate cell without Selecting a cell in HO/LTM. That is, the control unit 240 can determine an LTM candidate cell for transition based on a predetermined threshold among the LTM candidate cells, and can transition to the LTM candidate cell. In this case, the control unit 240 can apply the configuration relating to the LTM candidate cell and transition to the LTM candidate cell without a request to the gNB 100 on transition to the LTM candidate cell. A more detailed sequence will be described in detail in the operation example (see FIG. 7).

Further, the control unit 240 can acquire TA for the LTM candidate cell from the gNB 100 via the transmission and reception unit 210 before executing HO/LTM. The TA is a parameter that advances the transmission timing for the LTM candidate cell. If the UE 200 maintains the TA for the LTM candidate cell, it can transition to the LTM candidate cell without executing random access to the gNB 100 (omitting random access). Note that if the UE 200 does not maintain the TA for the LTM candidate cell, it can transition to the LTM candidate cell by executing random access to the gNB 100. The former is also called RACH-less fast recovery and the latter is called RACH-based fast recovery.

Further, in HO/LTM, if the selected cell is not an LTM candidate cell or if the reconfiguration information relating to the LTM described above is not included in the reconfiguration message transmitted from the gNB 100, the control unit 240 may request the gNB 100 on transition to the LTM candidate cell. Specifically, the control unit 240 may transmit an RRC re-establishment request to the gNB 100.

Further, after applying the configuration relating to the LTM candidate cell described above, the control unit 240 may start a timer. This timer is, for example, an LTM-timer described later. If the timer expires before transitioning to the LTM candidate cell, the control unit 240 may request the gNB 100 on transition to the LTM candidate cell. Specifically, the control unit 240 may transmit an RRC re-establishment request to the gNB 100.

Further, in HO/LTM, the control unit 240 may select a beam in a serving cell and execute BFR. In particular, the control unit 240 in the embodiment can select a beam in the LTM candidate cell if the BFR configuration information relating to the LTM candidate cell described above is included in the reconfiguration message transmitted from the gNB 100. For example, when a beam in a serving cell is equal to or less than a predetermined threshold, the control unit 240 can select a beam (exceeding the predetermined threshold) in the LTM candidate cell. Note that there may be a plurality of beams in a serving cell, and in this case, when all the beams in the serving cell are equal to or less than a predetermined threshold, the beam (exceeding the predetermined threshold) in the LTM candidate cell may be selected. Although the details of various types of configuration information (IE) that can be included in the reconfiguration message will be described later, the main ones will be described below.

The reconfiguration message may include configuration information relating to the LTM candidate cell, and the BFR configuration information relating to the LTM candidate cell may not be included in the configuration information relating to the LTM candidate cell. Furthermore, the BFR configuration information relating to the LTM candidate cell may include DL configuration information and UL configuration information, and at least one of the DL configuration information and the UL configuration information may include information relating to a beam in the LTM candidate cell.

Further, if the quality of the beam in the serving cell above described exceeds a predetermined threshold, the control unit 240 may select the beam in the serving cell instead of selecting the beam in the LTM candidate cell. Furthermore, if the quality of the beam in the LTM candidate cell is equal to or less than a predetermined threshold, the control unit 240 may request the gNB 100 on transition to the LTM candidate cell. Specifically, the control unit 240 may transmit an RRC re-establishment request to the gNB 100.

### (2.2) Functional Block Configuration of Base Station

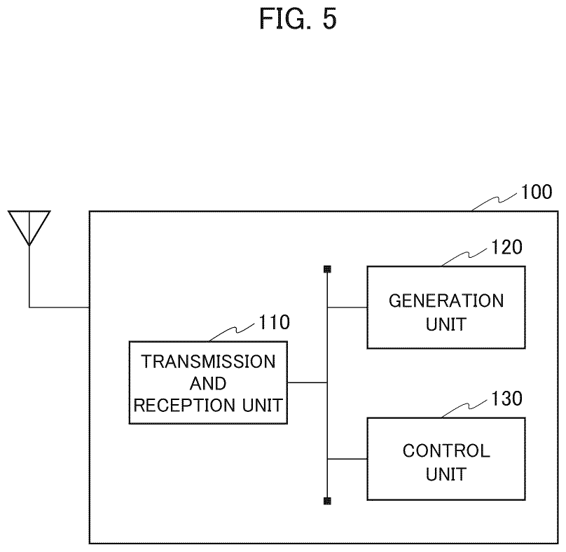

As illustrated in FIG. 5, the gNB 100 includes a transmission and reception unit 110, a generation unit 120, and a control unit 130.

The transmission and reception unit 110 transmits and receives radio signals to and from the UE 200. The transmission and reception unit 110 may include a transmission unit that transmits radio signals to the UE 200 and a reception unit that receives radio signals from the UE 200.

The transmission and reception unit 110 in the embodiment transmits a reconfiguration message (for example, RRC Reconfiguration) to the UE 200 in the RRC layer. The reconfiguration message may include various IEs such as configuration information (for example, LTM-Config) relating to a transition of a lower layer (LTM). The reconfiguration message in the embodiment may include, in particular, reconfiguration information (for example, attemptLTM-Reconfig) relating to LTM, and further may include BFR configuration information (for example, BFR-Config for LTM) relating to an LTM candidate cell. The IEs that can be included in the reconfiguration message will be described in detail in the operation examples.

The transmission and reception unit 110 in the embodiment may transmit a MAC Control Element (CE) to the UE 200 in the MAC layer. The MAC CE may include a Cell switch command (see FIG. 6).

The transmission and reception unit 110 in the embodiment receives the measurement report and various messages described above from the UE 200.

The generation unit 120 generates various messages such as the reconfiguration message and the Cell switch command described above.

The control unit 130 controls transmission and reception of radio signals by the transmission and reception unit 110, and generation of various messages by the generation unit 120.

The control unit 130 in the embodiment may prepare an LTM candidate cell based on the measurement report received via the transmission and reception unit 110. Further, the configuration information relating to the LTM candidate cell may be included in the reconfiguration message described above.

Further, the control unit 130 may control HO/LTM of the UE 200. The control unit 130 may control the HO in the L3 or the HO (LTM) in the L1/L2. Note that controlling the HO/LTM may mean determining the HO/LTM by the UE 200.

### (3) Operation of Radio Communication System

### (3.1) Problem

### (3.1.1) Problem 1

Fast recovery in LTM is a mechanism for transition to a candidate cell without a request to the base station on transition to the candidate cell when a predetermined condition is satisfied, similar to fast recovery in conditional handover (CHO), for example. However, the fast recovery in LTM has a problem in that a mechanism of fast recovery in CHO cannot be applied as is because an involvement of an RRC layer differs from that in the fast recovery in CHO. In the fast recovery in CHO, if the cell selected by the UE for reconnection is a candidate cell after a failure occurs, and further, if reconfigurationWithSync is present, the fast recovery is executed. In contrast, if reconfigurationWithSync is not present, an RRC re-establishment request is transmitted. There is a problem that such a mechanism cannot be applied to the fast recovery in LTM as is.

### (3.1.2) Problem 2

When a beam failure occurs in LTM, if another beam in a serving cell does not satisfy a predetermined condition (for example, the quality of the other beam satisfies or exceeds a predetermined threshold.), the UE requests the base station on transition to a candidate cell other than the serving cell. However, even in such a case, there may be a beam satisfying the predetermined condition in the candidate cell. In this case, there is a demand to recover from the beam failure by utilizing the beam satisfying the predetermined condition in the candidate cell.

### (3.2) Operation Example

### (3.2.0) Summary

An LTM sequence underlying the operation example will be described with reference to FIG. 6. The LTM sequence is broadly executed in the order of LTM preparation (step S01), early sync (step S02), LTM execution (step S03), and LTM completion (step S04).

First, on the premise that the UE 200 is in an RRC connection state with the gNB 100, the UE 200 transmits a measurement report to the qNB 100 (step S01-1). The measurement report includes, for example, a measurement result for the quality of the serving cell of the UE 200. Next, the gNB 100 prepares an LTM candidate cell (step S01-2) and transmits an RRC reconfiguration message to the UE 200 (step S01-3). The RRC reconfiguration message includes LTM-Config. The LTM-Config includes, for example, LTM-CandidateConfig which is the configuration information of an LTM candidate cell. In response to this, the UE 200 transmits an RRC reconfiguration completion message (step S01-4).

Next, the UE 200 executes DL/UL early sync for the LTM candidate cell formed by the gNB 100 (step S02). Specifically, the DL/UL early sync is executed by SSB/RACH or similar procedures. Thus, the UE 200 can acquire TA for the LTM candidate cell. The TA is a parameter that advances the transmission timing for the LTM candidate cell. Note that the UE 200 may not need to acquire the TA for the LTM candidate cell.

Next, the UE 200 transmits an L1 measurement report to the gNB 100 (step S03-1). The L1 measurement report includes, for example, a measurement result for the quality of the serving cell of the UE 200. Next, the gNB 100 determines the LTM (step S03-2) and transmits a MAC CE to the UE 200 (step S03-3). The MAC CE includes a cell switch command. In response to this, the UE 200 releases the connection with the serving cell and applies the configuration relating to the LTM candidate cell (step S03-4). Finally, the UE 200 executes RACH with the gNB 100 (step S03-5), thereby completing the transition to the LTM candidate cell (step S04). Note that if the UE 200 maintains the TA, step S03-5 can be omitted.

### (3.2.1) Operation Example 1

The operation example 1 will be described with reference to FIGS. 6 and 7. In the operation example 1, the LIM-Config (see step S01-3) may include an IE indicating enabling the UE 200 to support LTM fast recovery. This IE is, for example, attemptLTM-Reconfig which is reconfiguration information relating to a transition of a lower layer. Note that as described above, the “attemptLTM-Reconfig” is a tentative name, and other names may be used as long as the IE has a function to enable the UE 200 to support fast recovery in LTM.

Further, the RRC reconfiguration message (see step S01-3) may include not only LTM-Config but also other IEs necessary for the UE 200 to support LTM fast recovery. The other IE is, for example, SpCellConfig. The SpCellConfig includes, for example, LTM-CellSwitchInfo, which is information relating to a cell switch in a lower layer, and LTM-timer, which is a timer for determining the completion of fast recovery in LTM.

First, when RLF/HOF/LTM Failure is detected in the LIM sequence illustrated in FIG. 6 (specifically, step S02 or step S03) (step S11), the UE 200 measures the quality of the LTM candidate cell and determines to transition to the LTM candidate cell if the quality exceeds a predetermined threshold (YES in step S12). Further, when attemptLTM-Reconfig is included in the LTM-Config (YES in step S15), the UE 200 transitions to the LTM candidate cell that is determined in YES of step S12. Specifically, the configuration (LTM-CandidateConfig) relating to the LTM candidate cell is applied, and fast recovery can be executed in step S16 and subsequent steps, as described later. In LTM, a reference signal (RS) of the LTM candidate cell may be pre-configured in the UE 200, for example, in step S01-3 described above. Based on this RS, the UE 200 can measure the quality of the LTM candidate cell.

In contrast, if the quality of the LTM candidate cell does not exceed the predetermined threshold (NO in step S12), the UE 200 selects a cell to which it will reconnect (transition destination cell) (step S13). Further, the UE 200 may start timer T311 when starting cell selection. Note that step S12 may be omitted, and in this case, the processing proceeds from step S11 to step S13.

If the cell selected in step S13 (hereinafter also referred to as a selected cell) is the LTM candidate cell (YES in step S14) and attemptLTM-Reconfig is included in the LTM-Config (YES in step S15), the UE 200 can apply the configuration relating to the LTM candidate cell (LTM-CandidateConfig) and execute fast recovery in step S16 and subsequent steps, as described later. Note that the condition “attemptLTM-Reconfig is included in the LTM-Config” may be read as meaning “attemptLTM-Reconfig is included in the LTM-Config, and CellSwitchInfo and LTM-timer are included in the SpCellConfig” for the reasons described above.

After applying the LTM-CandidateConfig in YES of step S15, the UE 200 may start the LTM-timer included in the SpCellConfig. The LTM-timer may be, for example, timer T304.

After YES in step S15, if the UE 200 has acquired the TA in step S02 (YES in step S16), the UE 200 executes RACH-less fast recovery (step S17-1). The RACH-less fast recovery can reduce the time required for recovery because it allows transition to the LTM candidate cell without executing RACH, that is, random access, to the gNB 100 (i.e., by transmitting RRCReconfigurationComplete according to the UL grant resource allocation configured in advance from the gNB 100). Note that if the TA acquired by the UE 200 is not valid (for example, if the TA timer has expired), YES in step S16 may be read as meaning NO in step S16, and the processing may proceed to step S17-2 described later.

If the RACH-less fast recovery is successful (YES in step S18-1), the flowchart ends. If the RACH-less fast recovery fails because, for example, the LTM-timer expires before the fast recovery is completed (NO in step S18-1), the UE 200 requests the gNB 100 on transition to the LTM candidate cell (step S19). Specifically, the UE 200 transmits an RRC re-establishment request. Moreover, the UE 200 may start timer T301 after transmitting the RRC re-establishment request.

In contrast, if the UE 200 has not acquired the TA in the step S02 described above (NO in step S16), the UE 200 executes RACH-based fast recovery (step S17-2). The RACH-based fast recovery allows transition to the LTM candidate cell by executing RACH, that is, random access to the gNB 100 (see step S03).

If the RACH-based fast recovery is successful (YES in step S18-2), the flowchart ends. If the RACH-based fast recovery fails because, for example, the LTM-timer expires before the fast recovery is completed (NO in step S18-2), the UE 200 requests the gNB 100 on transition to the LTM candidate cell (step S19). Specifically, the UE 200 transmits an RRC re-establishment request. Moreover, the UE 200 may start the timer T301 after transmitting the RRC re-establishment request.

Further, in the case of NO in steps S14 and S15 described above, the UE 200 may proceed to step S19 and start the timer T301 in step S19. Specifically, if the selected cell is not an LTM candidate cell (NO in step S14) or if attemptLTM-Reconfig is not included in the LTM-Config (NO in step S15), the processing proceeds to step S19. Note that the condition “attemptLTM-Reconfig is not included in the LTM-Config” may be read as meaning “attemptLTM-Reconfig is not included in the LTM-Config, or either CellSwitchInfo or LTM-timer is not included in the SpCellConfig” for the reasons described above.

### (3.2.2) Operation Example 2

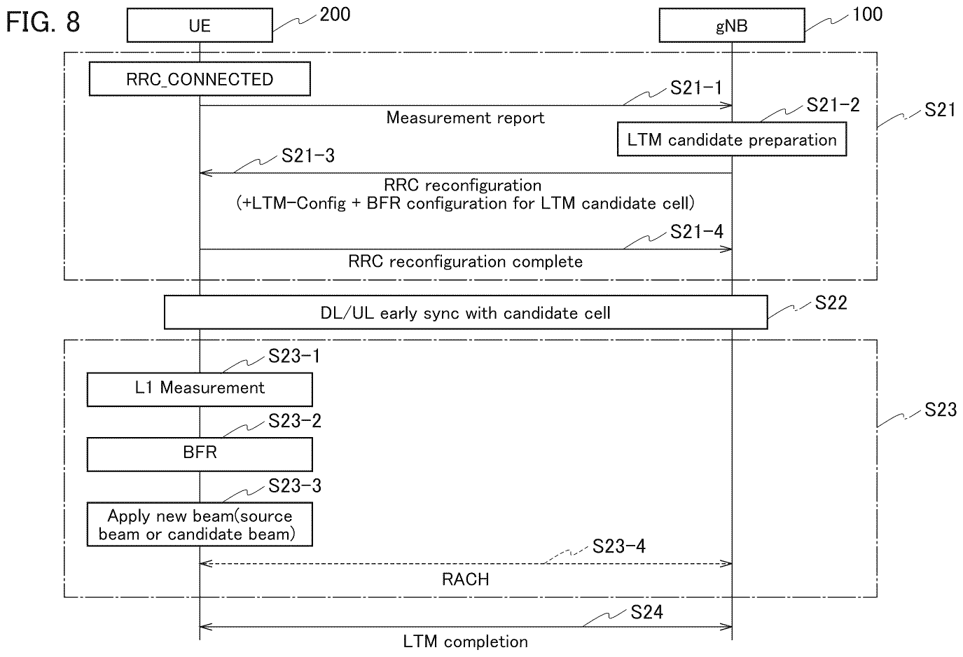

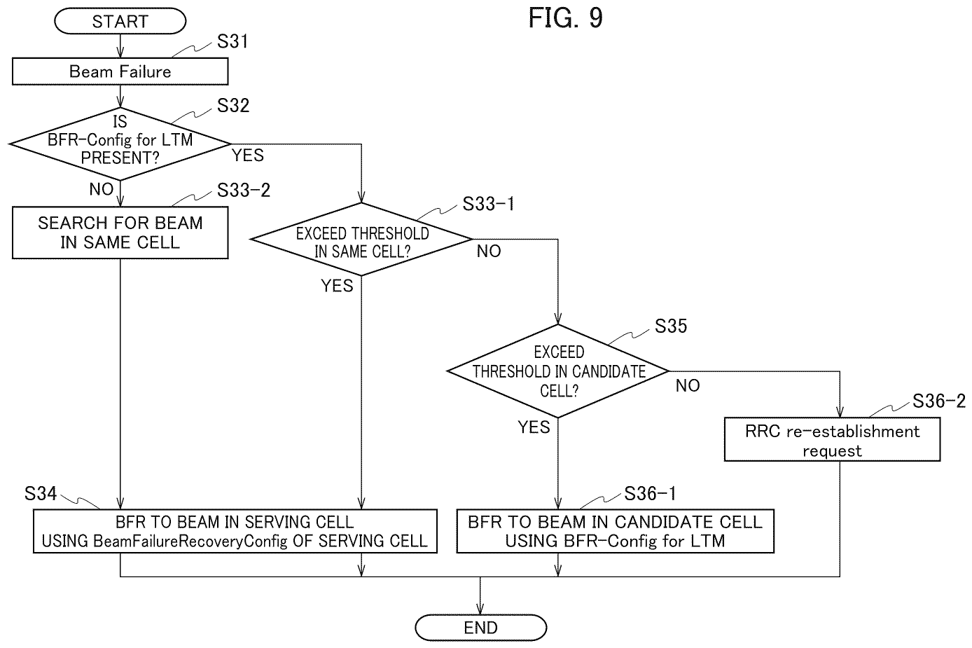

The operation example 2 will be described with reference to FIGS. 8 and 9. First, fast recovery in LTM when BF occurs will be described with reference to FIG. 8. The sequence of fast recovery in LTM when BF occurs has many parts in common with the sequence of LTM illustrated in FIG. 6. For example, step S22 is common to step S02 described above, so that its description will be omitted.

Also, in step S21, step S21-1, step S21-2, and step S21-4 are common to step S01-1, step S01-2, and step S01-4, respectively, so that their descriptions will be omitted. Therefore, step S21-3 will be described. In step S21-3, the gNB 100 transmits an RRC reconfiguration message to the UE 200. The RRC reconfiguration message includes LTM-Config. The LTM-Config includes, for example, LTM-CandidateConfig which is the configuration information of an LTM candidate cell. Moreover, the RRC reconfiguration message includes a configuration (hereinafter, it is also referred to as BFR configuration for LTM candidate cell or BFR-Config for LTM) for executing a beam failure recovery (BFR) for an LTM candidate cell. The BFR-Config for LTM is the BFR configuration information relating to the LTM candidate cell.

The BFR-Config for LTM may be positioned at a lower or higher level than the LTM-Config in the IE hierarchy included in the RRC reconfiguration message. In other words, the BFR-Config for LTM may be positioned to be included in the LTM-Config, or may be positioned not to be included in the LTM-Config. Similarly, the BFR-Config for LTM may be positioned at a lower or higher level than the LTM-CandidateConfig included in the LTM-Config. In other words, the BFR-Config for LTM may be positioned to be included in the LTM-CandidateConfig, or may be positioned not to be included in the LTM-CandidateConfig. In the latter case, the BFR-Config for LTM may be positioned so as to be included in the LTM-Config and not to be included in the LTM-CandidateConfig.

The BER-Config for LTM may include, for example, BWP-Downlink, which is downlink configuration information relating to the LTM candidate cell, and BWP-Uplink, which is uplink configuration information relating to the LTM candidate cell.

The BWP-Downlink may include IEs such as BWP-Id, BWP-Common, and BWP-Dedicated. The BWP-Dedicated may include BeamFailureRecoveryRSConfig. Furthermore, the BeamFailureRecoveryRSConfig may include configuration information relating to a beam of the LTM candidate cell (UL configuration information). Specifically, the CandidateBeamRSList in the BeamFailureRecoveryRSConfig may include configuration information relating to the beam of the LTM candidate cell (UL configuration information).

The BWP-Uplink may include IEs such as BWP-Id, BWP-Common, and BWP-Dedicated. The BWP-Dedicated may include BeamFailureRecoveryConfig. Furthermore, the BeamFailureRecoveryConfig may include configuration information relating to a beam of the LTM candidate cell (DL configuration information). Specifically, the CandidateBeamRSList in the BeamFailureRecoveryConfig may include configuration information relating to the beam of the LTM candidate cell (DL configuration information).

As described above, in step S21-3, the BFR configuration information relating to the LTM candidate cell may be configured in the UE 200, and further, the configuration information relating to the beam of the LTM candidate cell may be configured in the UE 200.

Further, the UE 200 may select the beam in the LTM candidate cell when maintaining both the BeamFailureRecoveryRSConfig and BeamFailureRecoveryConfig.

Returning to FIG. 8, step S23 will be described. It is assumed that BF has occurred after step S22, whose description is omitted, is completed. In L1, the UE 200 measures the quality of the beam in the serving cell formed by the gNB 100 or the quality of the beam in the candidate cell (step S23-1). Note that the RS for measuring the quality of the beam is the same as that of the operation example 1, and a detailed description thereof is omitted. After measuring the quality of the beam, the UE 200 selects a beam whose quality exceeds a predetermined threshold and executes the BFR (step S23-2). Further, the UE 200 applies the configuration relating to the selected new beam (step S23-3). Finally, the UE 200 executes RACH with the gNB 100 (step S23-4), thereby completing the selection of the new beam (step S24). Note that if the UE 200 maintains the TA, step S23-4 can be omitted.

The operation example 2 may be applied to an inter-CU LTM or an intra-CU LTM.

Finally, a specific flow of fast recovery in LTM when BF occurs will be described with reference to FIG. 9. First, if BF is detected in the LTM sequence in BF occurrence, which is illustrated in FIG. 8 (for example, between step S02 and step S03) (step S31), and the BFR-Config for LTM is configured in step S21-3 described above (YES in step S32), the UE 200 measures the beam in the same cell (serving cell). If the quality of the beam with the best quality among the beams in the serving cell exceeds a predetermined threshold (YES in step S33-1), the UE 200 executes BFR to the beam with the best quality (by the beam with the best quality) using the BeamFailureRecoveryConfig of the serving cell (step S34). Note that the BeamFailureRecoveryConfig may be included in the RRC reconfiguration message in step S21-3 described above and configured in the UE 200.

In contrast, if the BFR-Config for LTM is not configured in step S21-3 described above (NO in step S32), the UE 200 may search for a beam in the same cell (serving cell) (step S33-2) and proceed to step S34.

Here, returning to step S33-1, if the quality of the beam with the best quality among the beams in the serving cell is equal to or less than a predetermined threshold (NO in step S33-1), the UE 200 measures the beam in the LTM candidate cell. If the quality of the beam with the best quality among the beams in the LTM candidate cell exceeds the predetermined threshold (YES in step S35), the UE 200 executes BFR to the beam with the best quality (by the beam with the best quality) using the BFR-Config for LTM (step S36-1).

In contrast, if the quality of the beam with the best quality among the beams in the LTM candidate cell is equal to or less than a predetermined threshold (NO in step S35), the UE 200 requests the gNB 100 on transition to the LTM candidate cell (step S36-2). Specifically, the UE 200 transmits an RRC re-establishment request. Moreover, the UE 200 may start the timer T301 after transmitting the RRC re-establishment request.

### (4) Operation and Effect

According to the operation example 1 described above, the mechanism of fast recovery in LTM is rationalized, thereby achieving radio communication resistant to RLF/HOF/LTM Failure. In addition, according to the operation example 2 described above, the mechanism of BFR in LTM is improved, thereby achieving radio communication resistant to BF.

### (5) Other Embodiments

Above described, although the content of the present invention has been described in accordance with the embodiment, it is obvious to those skilled in the art that the present invention is not limited to the description of the embodiment and that various modifications and improvements thereof are possible.

In the disclosure described above, “exceeding a predetermined threshold” may be read as meaning “equal to or greater than a predetermined threshold”. In this case, “equal to or less than a predetermined threshold” may be read as meaning “falling below a predetermined threshold”.

In the disclosure described above, while step S12 for confirming whether a superior LTM candidate is present may be omitted, the other steps may also be omitted as appropriate. For example, step S16 for determining whether the UE 200 maintains the TA may be omitted, with the process proceeding to step S17-2 for executing the RACH-based fast recovery. Furthermore, steps S02 and S22 for executing early sync may be omitted, and in this case, this omission may be combined with the omission of step S16 described above.

In the disclosure described above, the radio communication system 10 may include a relay station (not illustrated) that relays radio communication between the UE 200 and the gNB 100. The relay station is, for example, a satellite such as a GEO (Geostationary Earth Orbit) Satellite, a MEO (Middle Earth Orbit) satellite, or a LEO (Low Earth Orbit) Satellite. Furthermore, the relay station may be a high-altitude infrastructure station (High Altitude Platform Station, HAPS) mounted on an airship, a balloon and so on, or a commercial aircraft (Air to Ground, ATG). When the relay station is included, propagation delay tends to be large, so the RACH-less fast recovery by means of pre-acquisition of the TA described above is more effective.

The above operation examples may be combined and applied in a complex manner as long as there is no conflict.

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

The block diagram (FIG. 4, FIG. 5) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but the functions are by no means limited to these. For example, a functional block (component) to implement a function of transmission may be referred to as a “transmitting section (transmitting unit),” a “transmitter”. The method for implementing each component is not particularly limited as described above.

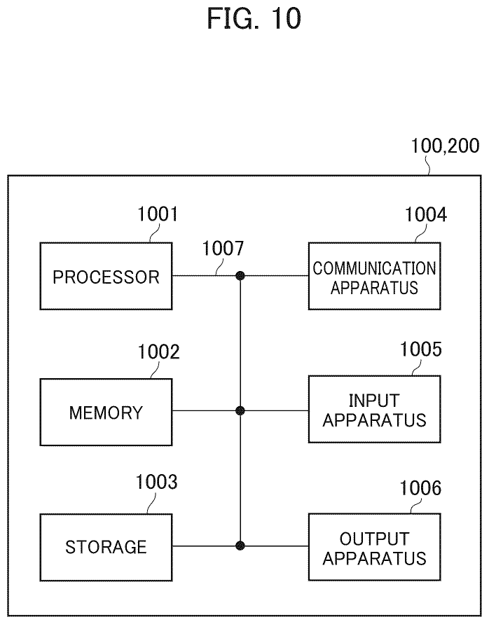

Furthermore, the above-described gNB 100 and UE 200 (the apparatus) may function as a computer that executes the processes of the radio communication method of the present disclosure. FIG. 10 is a diagram to show an example of a hardware structure of the apparatus. As shown in FIG. 10, the apparatus may each be formed as a computer apparatus that includes a processor 1001, a memory 1002, a storage 1003, a communication apparatus 1004, an input apparatus 1005, an output apparatus 1006, a bus 1007, and so on.

Note that in the following description, the word such as an apparatus can be read as a circuit, a device, a section, a unit, and so on. The hardware structure of the apparatus may be configured to include one or more of apparatuses shown in the drawings, or may be configured not to include part of apparatuses.

Each function block (FIG. 4, FIG. 5) of the apparatus is implemented by one of hardware elements or the combination of the hardware elements in the computer apparatus.

Each function of the apparatus is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The above-described various processes may be performed by a single processor 1001, or may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), and so on. The memory 1002 may be referred to as a “register,” a “cache,” a “main memory (primary storage apparatus)” and so on. The memory 1002 can store executable programs (program codes), software modules, and the like for implementing the method according to one embodiment of the present disclosure.

The storage 1003 is a computer-readable recording medium, and may be constituted with, for example, at least one of a compact disc (Compact Disc ROM (CD-ROM) and so on), a hard disk drive, a flexible disk, a magneto-optical disk (for example, a compact disc, a digital versatile disc, a Blu-ray (registered trademark) disk), a smart card, a flash memory device (for example, a card, a stick, and a key drive), a floppy (registered trademark) disk, a magnetic stripe, and so on. The storage 1003 may be referred to as “auxiliary storage apparatus.” The above recording medium may be a database including at least one of the memory 1002 and the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that performs output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, pieces of apparatus, including the processor 1001, the memory 1002, and others, are connected by a bus 1007 for communicating information. The bus 1007 may be formed with a single bus, or may be formed with buses that vary between pieces of apparatus.

Also, the apparatus may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information may be implemented by using physical layer signaling (for example, downlink control information (DCI), uplink control information (UCI)), higher layer signaling (for example, RRC signaling, Medium Access Control (MAC) signaling), broadcast information (master information block (MIB), system information block (SIB)), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), New radio access (NX), W-CDMA (registered trademark), GSM (registered trademark), CDMA 2000, Ultra Mobile Broadband (UMB), IEEE 802.11 (Wi-Fi (registered trademark)), IEEE 802. 16 (WiMAX (registered trademark)), IEEE 802.20, Ultra-WideBand (UWB), Bluetooth (registered trademark), systems that use other adequate systems, next-generation systems that are enhanced based on these. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Specific operations which have been described in the present disclosure to be performed by a base station may, in some cases, be performed by an upper node thereof. In a network including one or a plurality of network nodes with the base station, it is clear that various operations that are performed to communicate with a terminal can be performed by the base station and other network nodes (for example, Mobility Management Entities (MMES), Serving-Gateways (S-GWs), and so on may be possible, but these are not limiting) other than the base station, or combinations of these. According to the above, a case is described in which there is a single network node other than the base station. However, a combination of multiple other network nodes may be considered (e.g., MME and S-GW).

The information or signals may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A determination may be realized by a value (0 or 1) represented by one bit, by a boolean value (true or false), or by comparison of numerical values (e.g., comparison with a predetermined value).

Each aspect/embodiment described in the present disclosure may be used independently, may be used in combination, or may be used by switching according to operations. Further, notification of predetermined information (e.g., notification of “X”) is not limited to an explicit notification, and may be performed by an implicit notification (e.g., by not performing notification of the predetermined information).

Software should be broadly interpreted to mean, regardless of whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) and wireless technologies (infrared, microwave, etc.), at least one of these wired line technologies or wireless technologies is included within the definition of the transmission medium.

Information, a signal, or the like, described in the present disclosure may be represented by using any one of various different technologies. For example, data, an instruction, a command, information, a signal, a bit, a symbol, a chip, or the like, referred to throughout the above description, may be represented by a voltage, an electric current, electromagnetic waves, magnetic fields, a magnetic particle, optical fields, a photon, or a combination thereof.

It should be noted that a term described in the present disclosure and/or a term required for understanding of the present disclosure may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNodeB (eNB),” a “gNodeB (gNB),” an “access point,” a “transmission point,” a “reception point,” a “ transmission/reception point,” a “cell,” a “sector,” a “cell group,” a “carrier,” a “component carrier,” and so on can be used interchangeably. A base station may be referred to as the terms such as a “macro cell,” a “small cell,” a “femto cell,” a “pico cell,” and so on.

A base station can accommodate one or a plurality of (for example, three) cells (which may be referred to as sectors). When a base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases by the skilled person in the art.

At least one of a base station and a mobile station may be referred to as a “transmitting apparatus,” a “receiving apparatus,” a “communication apparatus,” and so on. Note that at least one of a base station and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, a base station in the present disclosure may be interpreted as a mobile station (user terminal, hereinafter the same). For example, each aspect/embodiment of the present disclosure may be applied to the structure that replaces a communication between a base station and a mobile station with a communication between a plurality of mobile stations (for example, which may be referred to as “Device-to-Device (D2D),” “Vehicle-to-Everything (V2X),” and the like). In this case, the mobile station may have the functions of the base station described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, a mobile station in the present disclosure may be interpreted as a base station. In this case, the base station may have the functions of the mobile station described above.

A radio frame may be constituted of one or a plurality of frames in the time domain. Each of one or a plurality of frames may be referred to as a “subframe” in the time domain.

Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of the number of symbols less than a slot. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI,” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIS (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit o 44 resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)), “a” sub-carrier group (SCG),” a “resource element group (REG),” a “PRB pair,” an “RB pair” and so on.

Furthermore, a resource block may be constituted of one or a plurality of resource elements (REs). For example, one RE may be a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of one or more wires, cables, and printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot”, depending on which standard is applied.

The phrase “based on” as used in the present disclosure does not mean “based only on”, unless otherwise specified. In other words, the phrase “based on” means both “based only on” and “based at least on”.

“Means” included in the configuration of each of the above apparatuses may be replaced by “parts”, “circuits”, “devices”, etc.

Reference to elements with designations such as “first,” “second,” and so on used in the present disclosure does not generally limit the quantity or order of these elements. These designations may be used in the present disclosure only for convenience, as a method for distinguishing between two or more elements Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present disclosure is not intended to be an “exclusive or”.

In the present disclosure, in the case where an article is added by translation, for example “a”, “an”, and “the”, the disclosure may include that the noun following these articles is plural.

As used in the present disclosure, the term “determining” may encompasses a wide variety of actions. For example, “determining” may be regarded as determining to have performed judging, calculating, computing, processing, deriving, investigating, looking up (looking up, search, inquiry) (e.g., looking up in a table, a database or another data structure), ascertaining and the like. Also, “determining” may be regarded as determining to have performed receiving (e.g., receiving information), transmitting (e.g., transmitting information), inputting, outputting, accessing (e.g., accessing data in a memory) and the like. Also, “determining” may be regarded as determining to have performed resolving, selecting, choosing, establishing, comparing and the like. That is, “determining” may be regarded as determining to have performed some action. Moreover, “determining” may be read as “assuming”, “expecting”, “considering”, and the like.

In this disclosure, the term “A and B are different” may mean “A and B are different from each other.” It should be noted that the term “A and B are different” may mean “A and B are different from C.” Terms such as “separated” or “combined” may be interpreted in the same way as the “different”.

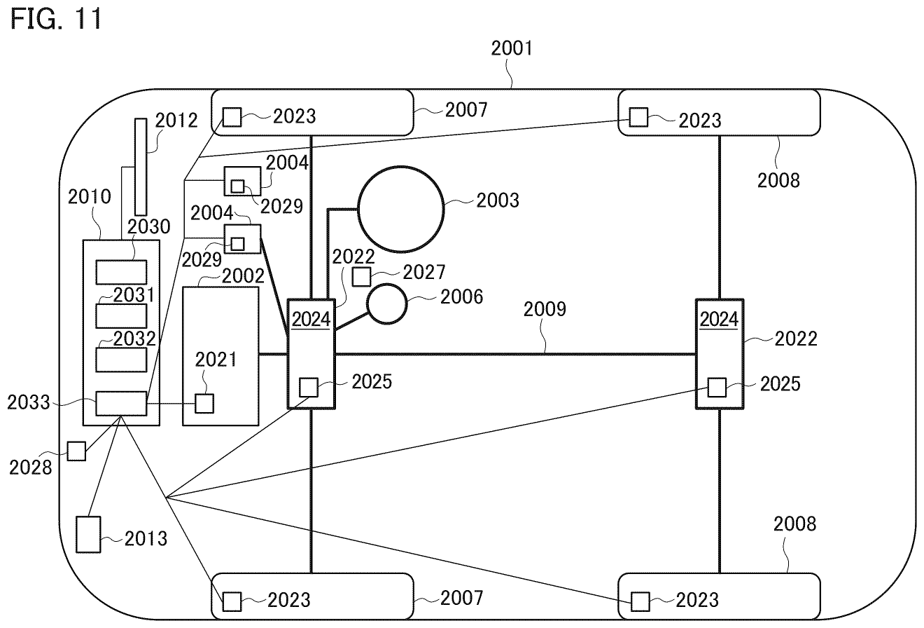

FIG. 11 shows an example of a configuration of a vehicle 2001. As shown in FIG. 11, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021-2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (10 port) 2033. The electronic control unit 2010 receives signals from the various sensors 2021-29 provided in the vehicle. The electronic control unit 2010 may be referred to as an ECU (Electronic Control Unit).

The signals from the various sensors 2021 to 2028 include a current signal from a current sensor 2021 which Senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

A driving support system unit 2030 includes: various devices for providing functions of preventing accidents and reducing driver's operating loads such as a millimeter wave radar, a LIDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and the sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits a current signal from a current sensor, which is input to the electronic control unit 2010, to external devices through radio communication. Also, the communication module 2013 transmits to external devices through radio communication, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like, which are input to the electronic control unit 2010.

The communication module 2013 receives various types of information (traffic information, signal information, inter-vehicle information, etc.) transmitted from the external devices and displays the received information on the information service unit 2012 provided in the vehicle 2001. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

As described above, the present disclosure has been described in detail. It is apparent to a person skilled in the art that the present disclosure is not limited to one or more embodiments described in the present disclosure. The present disclosure can be implemented as modifications and variations without departing from the subject matter and the scope of the present disclosure defined by the descriptions of claims. Therefore, the descriptions of the present disclosure are for illustrative purposes only, and are not intended to be any limitations to the present disclosure.

### Supplementary Notes

The above disclosure may be expressed as follows.

A first feature is a terminal including: a reception unit that receives a reconfiguration message from a base station in a radio resource control layer; and a control unit that transitions to a selected cell in a lower layer than the radio resource control layer, in which, the control unit, if the selected cell is a candidate cell in a transition of the lower layer and reconfiguration information relating to the transition of the lower layer is included in the reconfiguration message, applies a configuration relating to the candidate cell and transitions to the candidate cell without a request to the base station on transition to the candidate cell.

In the first feature, a second feature is the terminal in which the control unit transitions to the candidate cell without executing random access to the base station if the control unit maintains a parameter that advances a transmission timing for the candidate cell.

In the first feature, a third feature is the terminal in which the control unit transitions to the candidate cell by executing random access to the base station if the control unit does not maintain a parameter that advances a transmission timing for the candidate cell.

In any of the first to third features, a fourth feature is the terminal in which the control unit requests the base station on transition to the candidate cell if the selected cell c is not a candidate cell or if the reconfiguration information relating to the transition of the lower layer is not included in the reconfiguration message.

In any of the first to third features, a fifth feature is a terminal in which the control unit starts a timer after applying a configuration relating to the candidate cell, and requests the base station on transition to the candidate cell if the timer expires before transitioning to the candidate cell.

A sixth feature is a terminal including: a reception unit that receives a reconfiguration message from a base station in a radio resource control layer; and a control unit that in a lower layer than the radio resource control layer, transitions to a candidate cell determined based on a threshold among candidate cells in a transition of the lower layer, in which the control unit applies a configuration relating to the candidate cell and transitions to the candidate cell without a request to the base station on transition to the candidate cell.

### REFERENCE SIGNS LIST

10 radio communication system
20 NG-RAN
100 gNB
110 transmission and reception unit
120 generation unit
130 control unit
200 UE
210 transmission and reception unit
220 detection unit
230 generation unit
240 control unit
1001 processor
1002 memory
1003 storage
1004 communication apparatus
1005 input apparatus
1006 output apparatus
1007 bus
2001 vehicle
2002 drive unit
2003 steering unit
2004 accelerator pedal
2005 brake pedal
2006 shift lever
2007 right and left front wheels
2008 right and left rear wheels
2009 axle
2010 electronic control unit
2012 information service unit
2013 communication module
2021 current sensor
2022 rotational speed sensor
2023 pneumatic sensor
2024 vehicle speed sensor
2025 acceleration sensor
2026 brake pedal sensor
2027 shift lever sensor
2028 object detection sensor
2029 accelerator pedal sensor
2030 driving support system unit
2031 microprocessor
2032 memory (ROM, RAM)
2033 communication port

1. A terminal comprising:
a reception unit that receives a reconfiguration message from a base station in a radio resource control layer; and
a control unit that transitions to a selected cell in a lower layer than the radio resource control layer, wherein
the control unit, if the selected cell is a candidate cell in a transition of the lower layer and reconfiguration information relating to the transition of the lower layer is included in the reconfiguration message, applies a configuration relating to the candidate cell and transitions to the candidate cell without a request to the base station on transition to the candidate cell.

2. The terminal according to claim 1, wherein
the control unit transitions to the candidate cell without executing random access to the base station if the control unit maintains a parameter that advances a transmission timing for the candidate cell.

3. The terminal according to claim 1, wherein
the control unit transitions to the candidate cell by executing random access to the base station if the control unit does not maintain a parameter that advances a transmission timing for the candidate cell.

4. The terminal according to claim 1, wherein
the control unit: requests the base station on transition to the candidate cell if the selected cell is not a candidate cell or if the reconfiguration information relating to the transition of the lower layer is not included in the reconfiguration message.

5. The terminal according to claim 1, wherein
the control unit starts a timer after applying a configuration relating to the candidate cell, and requests the base station on transition to the candidate cell if the timer expires before transitioning to the candidate cell.

6. A terminal comprising:
a reception unit that receives a reconfiguration message from a base station in a radio resource control layer; and
a control unit that in a lower layer than the radio resource control layer, transitions to a candidate cell determined based on a threshold among candidate cells in a transition of the lower layer, wherein
the control unit applies a configuration relating to the candidate cell and transitions to the candidate cell without a request to the base station on transition to the candidate cell.
